(19) United States
(12) Patent Application Publication
(10) Pub. No.: US 2026/0129722 A1
(43) Pub. Date: May 7, 2026

(54) INDUCTION ENERGY TRANSMISSION SYSTEM

(71) Applicant: BSH Hausgeräte GmbH, Munich (DE)

(72) Inventors: Francisco Villuendas Lopez, Zaragoza (ES); Jesus Manuel Moya Nogues, Zaragoza (ES); Sergio Llorente Gil, Zaragoza (ES); Emilio Plumed Velilla, Zaragoza (ES); Jorge Tesa Betes, Zaragoza (ES); Jorge Pascual Aza, Zaragoza (ES)

(21) Appl. No.: 19/117,418

(22) PCT Filed: Nov. 6, 2023
(86) PCT No.: PCT/EP2023/080848

§ 371 Date: Apr. 1, 2025

(30) Foreign Application Priority Data
Nov. 11, 2022 (EP) 22383088

(51) Int. Cl. H05B 6/12; H02J 50/10

(52) U.S. Cl. CPC H05B 6/1236; H02J 50/10; H05B 2213/05

(57) ABSTRACT

An induction energy transmission system includes a set-down plate, a supply unit including a supply induction element arranged below the set-down plate and designed to inductively provide energy, a set-down unit including a receiving unit with a receiving induction element designed to receive the inductively provided energy, and a control unit designed to control the supply unit by using a parameter set so as to control the supply unit and to receive a parameter of the parameter set from the set-down unit. The control unit receives in addition an information parameter set from the set-down unit to determine a coefficient of a multivariable regression equation and based on the coefficient to determine a correction factor for a parameter of the parameter set or determine a new parameter set.

The invention relates to an induction energy transmission system according to the pre-characterizing clause of claim 1 and a method for operating an induction energy transmission system according to the pre-characterizing clause of claim 15.

Induction energy transmission systems for the inductive transmission of energy from a primary coil of a supply unit to a secondary coil of a set-down unit are already known from the prior art. By way of example, induction hobs are known which, in addition to inductively heating cooking equipment items, are also designed for the inductive energy supply of small household appliances. Control of the supply unit by a control unit is based on a parameter set, wherein in some known induction energy transmission systems at least one parameter of the parameter set, by way of example a self-inductance of the secondary coil, an energy requirement or a total electrical load, is transmitted wirelessly, by way of example via NFC, from the set-down unit to the control unit. The parameters of the parameter set, in particular parameters relating to the set-down unit, are assumed to be constant in previously known induction energy transmission systems and changes in these parameters occurring during operation are so far not taken into account. This results in disadvantageously long response times during commissioning or when changing loads, low efficiency in inductive energy transmission and the risk of potential damage to components, by way of example due to overvoltages caused by inaccurate parameters, which has reduced the operating convenience for users of previously known induction energy transmission systems.

The object of the invention lies in particular in, but is not limited to, providing a system of the generic type with improved properties in terms of operating convenience. The object is achieved in accordance with the invention by the features of claims 1 and 15, while advantageous embodiments and developments of the invention can be found in the subordinate claims.

The invention relates to an induction energy transmission system, in particular an induction cooking system, with a set-down plate, with a supply unit that has at least one supply induction element arranged below the set-down plate for the inductive provision of energy, with a control unit for controlling the supply unit, and with at least one set-down unit, which has at least one receiving unit with at least one receiving induction element for receiving the energy provided inductively, wherein the control unit is designed to use a parameter set so as to control the supply unit and to receive at least one parameter of the parameter set from the set-down unit.

It is proposed that the control unit is designed to receive in addition an information parameter set from the set-down unit, to use this to determine coefficients of at least one multivariable regression equation and from this to determine at least one correction factor for at least one parameter of the parameter set or determine a new parameter set.

An induction energy transmission system with improved properties in terms of operating convenience can be advantageously provided by such an embodiment. In particular, an improved user experience can be made possible by shortening a transient recovery time between the supply induction element and the receiving induction element and by enabling more precise control and faster response to changing conditions, such as a shifting of the set-down unit on the set-down plate, for example. Furthermore, operational reliability can be advantageously improved. In particular, it is possible to reduce, preferably minimize, hazards resulting from damage to electronic components of the induction energy transmission system, by way of example due to overvoltages and/or changes in an electromagnetic coupling between the supply induction element and the receiving induction element.

The induction energy transmission system has at least one main functionality in the form of wireless energy transmission, in particular in a wireless energy supply of set-down units. In one advantageous embodiment, the induction energy transmission system is configured as an induction cooking system with at least one further main function that differs from a purely cooking function and is in particular at least supplying energy and operating small household appliances. By way of example, the induction energy transmission system could be configured as an induction oven system and/or as an induction grill system. In particular, the supply unit could be configured as a part of an induction oven and/or as part of an induction grill. The induction energy transmission system configured as an induction cooking system is preferably configured as an induction hob system. The supply unit is then configured in particular as part of an induction hob. In a further advantageous embodiment, the induction energy transmission system is configured as a kitchen energy supply system and, in addition to a main function in the form of an energy supply and operation of a small household appliance, can be designed for the provision of cooking functions.

A “supply unit” is to be understood as a unit which in at least one operating state inductively provides energy and which has in particular a main functionality in the form of energy provision. For the provision of energy, the supply unit has at least one supply induction element which has in particular at least one coil, in particular at least one primary coil and/or is configured as a coil and which in particular in the operating state inductively provides energy. The supply unit could have at least two, in particular at least three, advantageously at least four, in particular advantageously at least five, preferably at least eight, and particularly preferably multiple, supply induction elements which in the operating state could each inductively provide energy and namely in particular to a single receiving induction element or to at least two or multiple receiving induction elements at least of one set-down unit and/or at least one further set-down unit. At least one part of the supply induction elements could be arranged in close proximity to one another, by way of example in a row and/or in the form of a matrix. The supply unit preferably has at least one compensation capacitor which can be electrically connected in parallel or in series to the supply induction element and which can be designed in particular for reactive power compensation.

A “control unit” is to be understood as an electronic unit which is designed for open-loop control and/or closed-loop control of at least the supply unit. The control unit comprises a computing unit and in particular, in addition to the computing unit, a storage unit with at least one open-loop and/or closed-loop control program which is stored therein and is designed to be executed by the computing unit. The control unit has at least one inverter unit. The inverter unit preferably performs a frequency conversion in the operating state and in particular converts a low-frequency alternating voltage on the input side into a high-frequency alternating voltage on the output side. Preferably, the low-frequency alternating voltage has a frequency of at most 100 Hz. Preferably, the high-frequency alternating voltage has a frequency of at least 1000 Hz. Preferably, the inverter unit is designed to adjust the energy inductively provided by the at least one supply induction element by adjusting the high-frequency alternating voltage. Preferably, the control unit comprises at least one rectifier. The inverter unit has at least one inverter switching element. Preferably, the inverter switching element generates an oscillating electric current for operating the at least one supply induction element, preferably at a frequency of at least 15 kHz, in particular at least 17 kHz and advantageously at least 20 kHz. Preferably, the inverter unit comprises at least two inverter switching elements, which are preferably configured as bipolar transistors with an insulated-gate electrode and in particular advantageously at least one damping capacitor.

A “set-down unit” is to be understood as a unit which, in at least one operating state, inductively receives energy and converts the inductively received energy at least partially into at least one other form of energy for the provision of at least one main function. By way of example, the energy inductively received by the set-down unit could be converted, in particular directly, into at least one other form of energy, such as heat, in the operating state. Alternatively or additionally, the set-down unit could have at least one electrical consumer, such as an electric motor or the like. The set-down unit has at least one receiving unit with a receiving induction element for receiving the inductively provided energy. The receiving unit could have in particular at least two, in particular at least three, advantageously at least four, in particular advantageously at least five, preferably at least eight and particularly preferably multiple receiving induction elements which, in particular in the operating state, could each inductively receive energy, in particular from the supply induction element. The set-down unit could be configured by way of example as a cooking equipment item. The cooking equipment item preferably has at least one food receiving cavity and in the operating state converts the inductively received energy at least in part into heat so as to heat foods arranged in the food receiving cavity. The set-down unit configured as a cooking equipment item preferably has at least one further unit, so as to provide at least one further function, which goes beyond the mere heating of foods and/or does not involve heating foods. By way of example, the further unit could be configured as a temperature sensor or as a mixing unit or the like. Alternatively, the set-down unit could be configured as a small household appliance. Preferably, the small household appliance is a non-stationary household appliance which has at least the receiving induction element and at least one functional unit which provides at least one household appliance function in an operating state. In this context, “non-stationary” is to be understood to mean that the small household appliance can be positioned freely by a user in a household, and in particular without aids, in particular in contrast to a large household appliance, which is permanently positioned and/or installed at a specific location in a household, such as an oven or a refrigerator. Preferably, the small household appliance is configured as a small kitchen appliance and, in the operating state, provides at least one main function for processing foods. The small household appliance could, by way of example, but is not limited to this, be configured as a food processor and/or as a blender and/or as a mixer and/or as a grinding mill and/or as a set of kitchen scales or as a kettle or as a coffee machine or as a rice cooker or as a milk frother or as a deep fryer or as a toaster or as a juicer or as a slicing machine or the like.

The receiving induction element of the receiving unit comprises at least one secondary coil and/or is configured as a secondary coil. In an operating state of the set-down unit, the receiving induction element supplies at least one consumer of the set-down unit with electrical energy. Furthermore, it is conceivable that the set-down unit has an energy store, in particular a rechargeable battery, which is designed to store electrical energy received via the receiving induction element in a charge state and to make it available in a discharge state so as to supply the functional unit. Preferably, the receiving unit has at least one compensation capacitor, which is electrically connected in parallel or in series to the receiving induction element and which may in particular be designed for reactive power compensation.

A “set-down plate” is to be understood as at least one, in particular plate-like, unit of the induction energy transmission system, which is designed for setting down at least one set-down unit and/or for placing at least one item of food to be cooked on it. The set-down plate could be configured by way of example as a worktop, in particular a kitchen worktop, or part of at least one worktop, in particular at least one kitchen worktop, in particular of the induction energy transmission system. Alternatively or additionally, the set-down plate could be a hob plate. The set-down plate configured as a hob plate could in particular form at least part of an outer housing of the hob and in particular, together with at least one outer housing unit, to which the set-down plate configured as a hob plate could in particular be connected in at least one installed state, could form at least to a large extent the outer housing of the hob. The set-down plate is preferably made of a non-metallic material. The set-down plate could, by way of example, be formed at least to a large extent from glass and/or glass ceramic and/or Neolith and/or Dekton and/or wood and/or marble and/or stone, in particular natural stone, and/or laminate and/or plastic and/or ceramic. In the present document, references to positions, such as “below” or “above”, relate to an installed state of the set-down plate, unless explicitly described otherwise. In the installed state, the supply unit is preferably arranged below the set-down plate.

The induction energy transmission system preferably comprises a communication unit. The communication unit is preferably designed for bidirectional wireless data transmission, i.e. for both wireless reception and wireless transmission of data between the control unit and the set-down unit. Preferably, the communication unit has at least one communication element that is connected to the control unit and is designed in particular for wireless reception and transmission of data. Preferably, the communication unit has at least one further communication element, which is arranged within the set-down unit and is designed in particular for wireless reception and transmission of data. The communication unit could be designed for wireless data transmission between the set-down unit and the control unit via RFID, or via WIFI, or via Bluetooth or via ZigBee, or for wireless data transmission according to another suitable standard. Preferably, the communication unit is designed for wireless data transmission between the set-down unit and the control unit via NFC. Preferably, the control unit is designed to receive the at least one parameter of the parameter set wirelessly from the set-down unit, and namely by means of the communication unit.

A “parameter set” is to be understood as a plurality of at least two parameters which the control unit uses to control the supply and with the aid of which the control unit controls the energy inductively provided by the supply unit according to a type of the set-down unit and/or according to a prevailing operating state of the set-down unit that can be selected in particular by a user of the induction energy transmission system. The parameter set preferably comprises at least one constant design-related and/or geometric characteristic variable of the supply induction element and/or of the receiving induction element. Design-related and/or geometrical characteristic variables could comprise, without being limited thereto, by way of example, a shape and/or size, in particular a radius and/or internal diameter and/or an external diameter, and/or a cross-sectional area and/or a number of windings and/or a material and/or a spatial position of the receiving induction element within the set-down unit and/or could be a vertical distance of the supply induction element from the set-down plate and/or the like.

Preferably, at least one parameter of the parameter set comprises an electrical characteristic variable, in particular a time-varying electrical characteristic variable, of the supply induction element and/or of the receiving induction element, by way of example the magnitude of electrical resistances and/or impedances in a primary circuit of the supply unit and/or in a secondary circuit of the receiving unit and/or inductances, in particular self-inductances, and/or magnetic flux densities of the supply induction element and/or of the receiving induction element and/or a resonance frequency and/or a material constant, by way of example a magnetic permeability of a magnetic flux focusing element of the supply unit and/or of the receiving unit. Moreover, at least one parameter of the operating parameter set can comprise at least one operating characteristic variable for the set-down unit, by way of example a maximal power and/or a minimal power and/or number of power levels and/or a number and/or type of operable electrical loads and/or a voltage and/or current strength required in an operating state.

An “information parameter set” is to be understood as a plurality of at least two information parameters which are stored in a storage unit of the set-down unit and which the control unit receives in an operating state of the induction energy transmission system from the set-down unit, preferably wirelessly via the communication unit. The information parameter set comprises at least one, preferably at least two and preferably at least three information parameters, which were measured in a standardized test. The information parameter(s) measured in the standardized test may be, without being limited thereto, a self-inductance of the supply induction element and/or a self-inductance of a supply induction element used for the standardized test and/or a coupling factor between the supply induction element and the supply induction element used for the standardized test. Preferably at least two, preferably at least three, and particularly preferably at least four information parameters are stored in the storage unit of the set-down unit, the information parameters having been measured in various standardized tests, wherein the various standardized tests differ from one another at least with respect to one test parameter. By way of example, the receiving induction element and the supply induction element that is used for the standardized test can be arranged during a first standardized test at a first vertical distance with respect to one another and without a horizontal offset with respect to one another, during a second standardized test at the first vertical distance with respect to one another and with a predetermined horizontal offset with respect to one another, during a third standardized test at a second distance that is different from the first distance and without a horizontal offset with respect to one another and during a fourth standardized test at the second distance and with the predetermined horizontal offset with respect to one another. Alternatively or additionally, it is also conceivable that different supply induction elements, which may differ, by way of example, in terms of their material and/or their inner diameter and/or their outer diameter and/or their number of windings and/or the like, are used for various standardized tests.

The at least one multivariable regression equation can be stored in the storage unit of the control unit. Alternatively or additionally, it is also conceivable that the at least one multivariable regression equation is stored in the storage unit of the set-down unit and received by the control unit in the operating state, in particular wirelessly via the communication unit. The multivariable regression equation has at least two coefficients but it can also have more than two coefficients. The control unit can be designed to use the information parameter set to determine coefficients of the multivariable regression equation to determine a correction factor of a parameter of the parameter set, by way of example the self-inductance of the supply induction element, and to determine further coefficients of a further regression equation to determine a further correction factor of another parameter of the parameter set, by way of example the self-inductance of the receiving induction element. The control unit is designed to calculate at least one coefficient of the multivariable regression equation, wherein at least one calculation rule, in particular one or more formulas, for calculating this coefficient can be stored in the storage unit of the control unit. It is also conceivable that the at least one calculation rule is stored in the control unit of the set-down unit and the control unit is designed to receive this from the set-down unit, in particular wirelessly via the communication unit, together with the information parameter set and/or as an information parameter of the information parameter set. At least one coefficient of the multivariable regression equation can be constant, wherein the control unit can be designed to receive this constant coefficient as an information parameter of the information parameter set, in particular wirelessly via the communication unit, from the set-down unit.

The control unit can be designed to create a digital twin of the set-down unit by means of at least one specific correction factor and/or the new parameter set, and to store in the storage unit a parameter set specially adapted to the set-down unit, so that when the set-down unit is operated again, it is advantageous to avoid having to determine at least one correction factor again and efficiency can be increased.

In the present document, number words, such as “first” and “second”, which are placed before certain terms, are used merely to distinguish between objects and/or to assign objects to one another and do not imply an existing total number and/or ranking of the objects. In particular, a “second object” does not necessarily imply the presence of a “first object”.

“Provided” is to be understood to mean especially programmed, configured and/or equipped. The expression that an object is designed for a specific function is to be understood that the object fulfills and/or performs this specific function in at least one application state and/or operating state.

It is also proposed that the control unit is designed to take into account a horizontal offset between the supply induction element and the receiving induction element when determining the new parameter set. This can advantageously further improve operating convenience. In particular, it can increase accuracy when determining the new parameter set. In the present document, a “horizontal offset” is understood to refer to a distance between a geometric center of the supply induction element and a geometric center of the receiving induction element parallel to a main extent plane of the set-down plate. A “main extent plane” of a component is to be understood as a plane that is parallel to a largest side surface of a smallest imaginary cuboid that just completely encloses the component and in particular runs through the center of the cuboid.

In addition, it is proposed that the control unit is designed to determine a correction factor for a self-inductance of the supply induction element. This can advantageously further improve operating convenience. In particular, a more precise value of the self-inductance of the supply induction element, which in previously known induction energy transmission systems from the prior art is assumed to be constant for the sake of simplicity, can be used for the operation of the supply unit, thus enabling more efficient operation of the induction energy transmission system. Furthermore, it is proposed that the control unit is designed to determine a correction factor for a self-inductance of the receiving induction element. Operating convenience can be further improved by such a design. In particular, a more precise value of the self-inductance of the receiving induction element, which in previously known induction energy transmission systems from the prior art is assumed to be constant for the sake of simplicity, can be used for the operation of the supply unit, whereby the efficiency of the operation of the induction energy transmission system can be further improved.

Furthermore, it is proposed that the control unit is designed to determine a correction factor for a load resistance of the set-down unit. This can advantageously enable a particularly efficient and safe operation. Such an embodiment is particularly advantageous when operating set-down units that have a load resistance that fluctuates during operation, by way of example due to a drive motor for a stirring unit or the like, since the correction factor can be used by the control unit to take into account fluctuations in the load resistance when controlling the supply unit by adjusting the power provided. Preferably, the control unit is designed to determine the correction factor for the load resistance of the set-down unit with a time delay of at most one cycle of an AC mains voltage, i.e., by way of example, at a mains frequency of 50 Hz with a delay of at most 20 ms.

In addition, it is proposed that the set-down plate be configured as a hob plate. An induction energy transmission system configured as an induction cooking system with the advantageous properties mentioned above can be provided by means of such an embodiment, which, in addition to inductively supplying energy to small household appliances via the supply unit in accordance with the embodiments described above, also makes it possible to heat cooking equipment items.

In an alternative advantageous embodiment, it is proposed that the set-down plate is configured as a kitchen worktop. This makes it possible to provide an induction energy transmission system with the aforementioned advantageous properties as well as a particularly high degree of aesthetics and functionality. In addition, a fascination with inductive energy transmission can be increased if the set-down plate is configured as a kitchen worktop, since some components of the induction energy transmission system, in particular the supply unit, remain completely invisible to the user under the kitchen worktop and this can create the impression that the set-down unit is operated without any energy source. Even in the case of a set-down plate configured as a kitchen worktop, the induction energy transmission system could be configured as an induction cooking system, wherein the supply unit could be designed not only to supply energy inductively to set-down units configured as small household appliances but also to provide induction heating for cooking equipment items.

Furthermore, it is proposed that the control unit is designed to use a vertical distance between the supply induction element and an upper side of the set-down plate when determining the coefficients of the multivariable regression equation. This can advantageously enable a more precise determination of the correction factor. In particular, it is possible to take into account different types of set-down plates, which can be designed either as a hob plate or as a kitchen worktop and below which the supply unit can be arranged at different vertical distances. Preferably, the vertical distance between the supply induction element and the upper side of the set-down plate is stored in the storage unit of the control unit. Furthermore, it is proposed that the information parameter set contains a vertical distance between the receiving induction element and the upper side of the set-down plate. Such an embodiment can advantageously further increase accuracy when determining the at least one correction factor. Preferably, the vertical distance between the receiving induction element and an upper side of the set-down plate is stored in the storage unit of the set-down unit and the control unit is designed to receive this from the set-down unit, in particular as an information parameter and in particular wirelessly by means of the communication unit. Preferably, the control unit is designed to add the vertical distance between the supply induction element and the upper side of the set-down plate and the vertical distance between the receiving induction element and the upper side of the set-down plate in order to determine a distance between the supply induction element and the receiving induction element. The vertical distance between the supply induction element and the upper side of the set-down plate is measured starting from the geometric center of the supply induction element and extends starting from the geometric center of the supply induction element along an imaginary straight line, which runs perpendicular to the main extent plane of the set-down plate, to a point of intersection of this straight line with the upper side of the set-down plate. The vertical distance between the receiving induction element and the upper side of the set-down plate is measured starting from the geometric center of the receiving induction element and extends starting from the geometric center of the receiving induction element along an imaginary straight line, which runs perpendicular to the main extent plane of the set-down plate, to a point of intersection of this straight line with the upper side of the set-down plate.

It is also proposed that the information parameter set comprises at least one geometric information parameter of the receiving induction element. This can advantageously increase accuracy when determining the at least one correction factor and/or the new parameter set. A geometric information parameter may be, but is not limited to, by way of example an inner diameter and/or an outer diameter and/or a thickness of the receiving induction element. Preferably, the information parameter set comprises several geometric information parameters.

It is further proposed that the set-down unit has a shielding unit and that the information parameter set comprises at least one information parameter relating to the shielding unit. This can advantageously increase accuracy when determining the at least one correction factor and/or the new parameter set. In addition, sensitive components of the set-down unit can be effectively protected by the shielding unit against interference from the alternating electromagnetic field acting in an operating state of the supply unit. The information parameter relating to the shielding unit can, by way of example, be information relating to a material of the shielding unit which it has and/or of which it is made, by way of example aluminum and/or iron.

It is further proposed that the receiving unit comprises a flux-bundling unit and the information parameter set comprises at least one information parameter relating to the flux-bundling unit. If the receiving unit has a flux-bundling unit, efficiency in the inductive energy supply of the set-down unit can be advantageously improved. Moreover, if the information parameter set comprises at least one information parameter relating to the flux-bundling unit, accuracy when determining the at least one correction factor and/or the new parameter set can be advantageously further increased. Preferably, the flux-bundling unit has at least one flux-bundling element which is configured as a ferrite. The information parameter relating to the flux-bundling unit may comprise, by way of example, but is not limited thereto, information relating to a number of ferrites of the flux-bundling unit and/or relating to an area or multiple areas in which the ferrite(s) are arranged.

The invention also relates to a set-down unit, in particular a small household appliance, of an induction energy transmission system according to one of the embodiments described above. Such a set-down unit is characterized in particular by increased operating convenience in an operation within the induction energy transmission system.

The invention also relates to an induction household appliance, in particular an induction hob, of an induction energy transmission system according to one of the embodiments described above, which comprises the supply unit and the control unit. Such an induction household appliance is characterized in particular by increased operating convenience in an operation within the induction energy transmission system.

The invention further relates to a method for operating an induction energy transmission system, in particular according to one of the embodiments described above, with a set-down plate, with a supply unit which has at least one supply induction element arranged below the set-down plate for the inductive provision of energy, and with at least one set-down unit, which has at least one receiving unit with at least one receiving induction element for receiving the inductively provided energy, wherein a parameter set is used so as to control the supply unit and at least one parameter of the parameter set is provided by the set-down unit.

It is proposed that an information parameter set is additionally provided by the set-down unit, which is used to determine coefficients of at least one multivariable regression equation, from which is determined at least one correction factor for at least one parameter of the parameter set or a new parameter set is determined. This can advantageously provide a particularly user-friendly and efficient method for operating the induction energy transmission system.

The induction energy transmission system is not intended to be limited to the application and embodiment described above. In particular, the induction energy transmission system may have a number of individual elements, components and units other than the number of elements, components and units described herein in order to fulfill a function described herein.

Further advantages are shown in the following description of the drawing. Two exemplary embodiments of the invention are shown in the drawing. The drawing, the description and the claims contain numerous features in combination. The person skilled in the art will also expediently consider the features individually and combine them to form useful further combinations.

In the drawing:

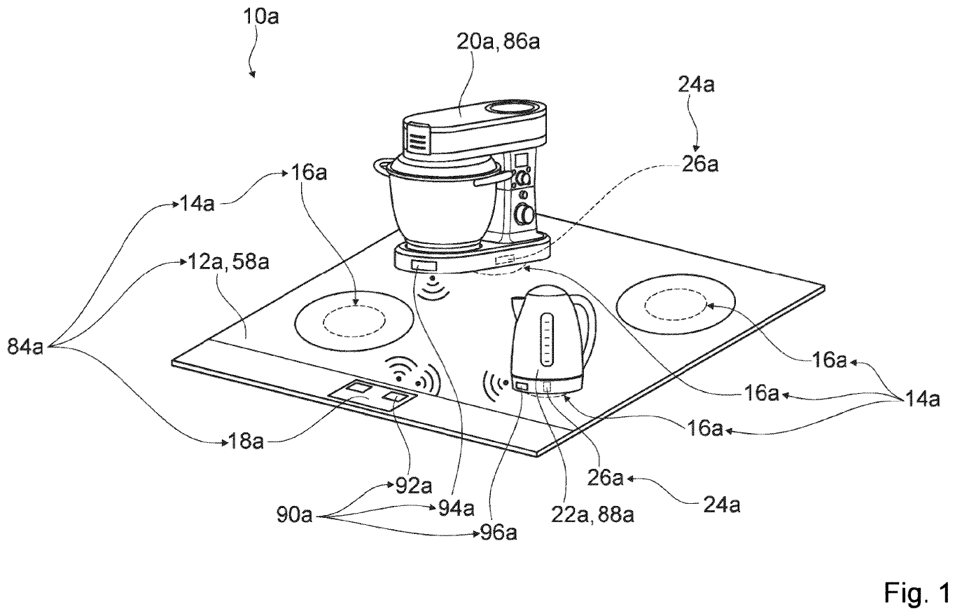

FIG. 1 shows a schematic representation of an induction energy transmission system with a supply unit, a control unit for the open-loop control of the supply unit, a set-down unit and a further set-down unit which each comprise a receiving unit,

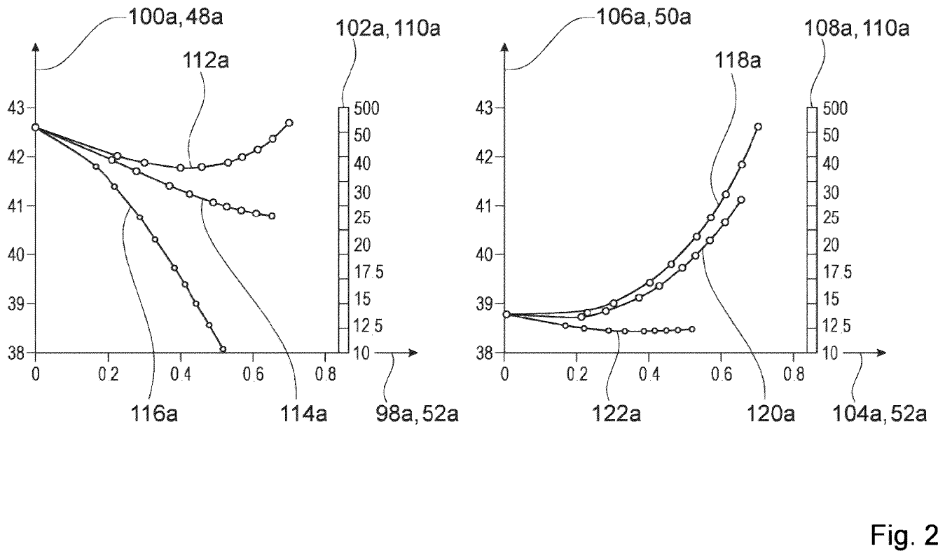

FIG. 2 shows two schematic diagrams illustrating the influencing variables on the self-inductances of a supply induction element of the supply unit and a receiving induction element of the receiving unit,

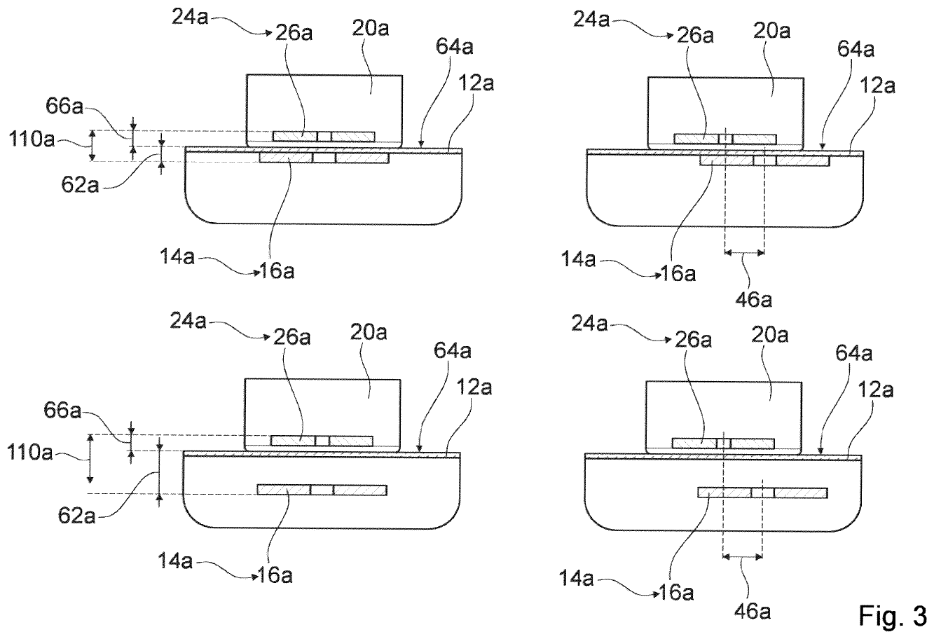

FIG. 3 shows four schematic illustrations of possible arrangements between the supply element and the receiving induction element,

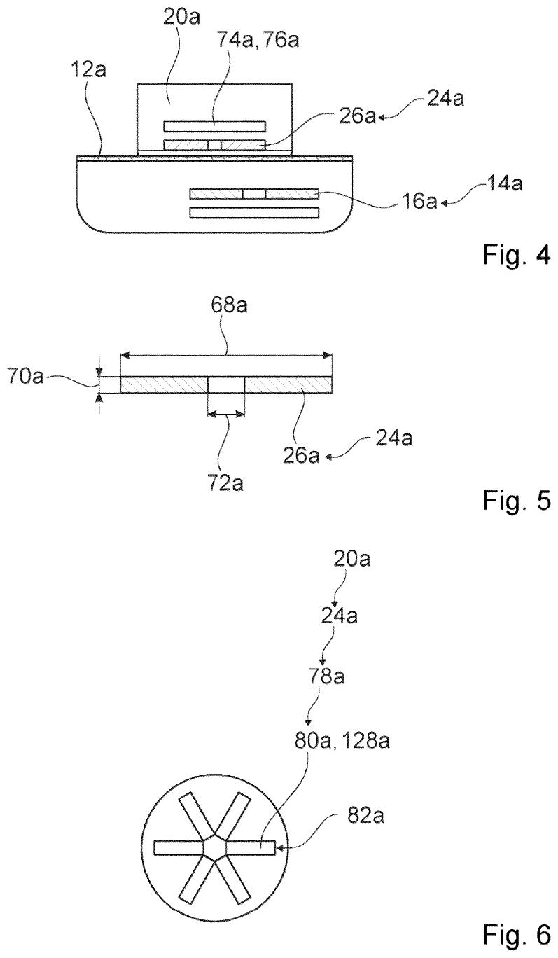

FIG. 4 shows a schematic representation of the supply unit and the set-down unit with a shielding unit,

FIG. 5 shows a schematic representation of the receiving unit of the set-down unit,

FIG. 6 shows a schematic representation of the flux-bundling unit of the set-down unit,

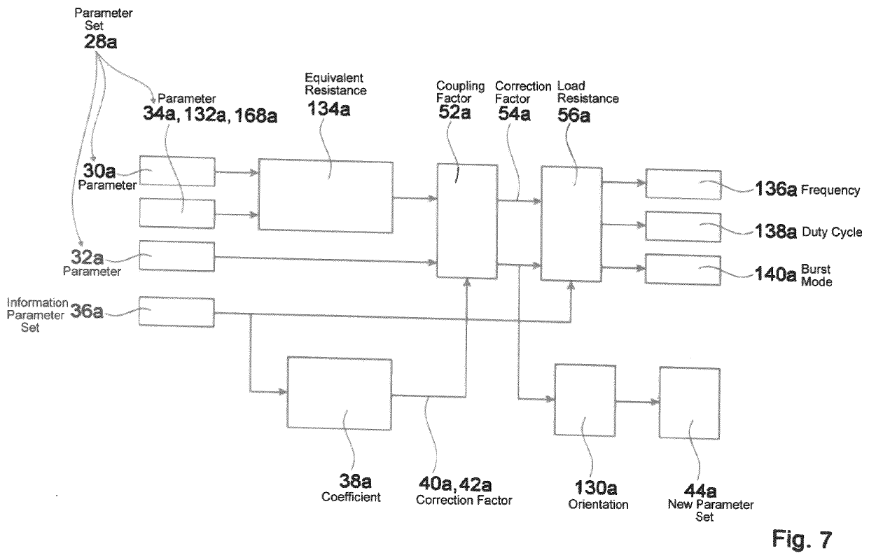

FIG. 7 shows a schematic block diagram for illustrating an operating principle of the control unit,

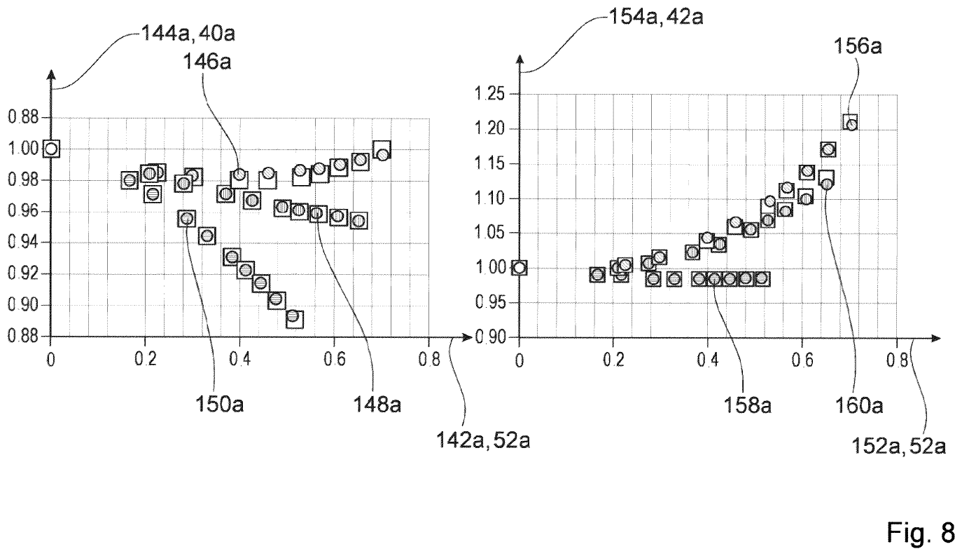

FIG. 8 shows two schematic diagrams for illustrating correction factors for parameters of a parameter set, by means of which the control unit operates the supply unit,

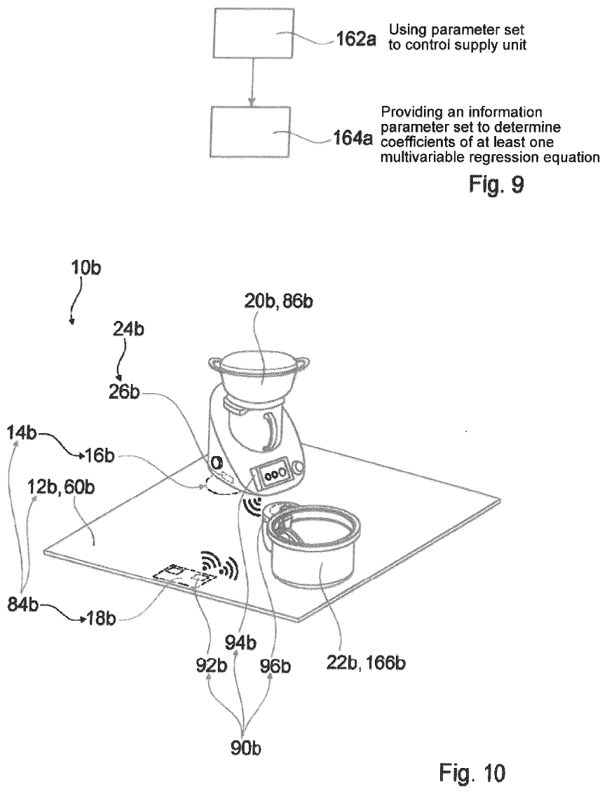

FIG. 9 shows a schematic method flow chart of a method for operating the induction energy transmission system, and

FIG. 10 shows a schematic representation of a further exemplary embodiment of an induction energy transmission system with a supply unit, a control unit of a set-down unit and a further set-down unit.

FIG. 1 shows a schematic representation of an induction energy transmission system 10a. The induction energy transmission system 10a has a set-down plate 12a. In the present case, the induction energy transmission system 10a is configured as an induction cooking system and comprises an induction household appliance 84a. In the present case, the induction household appliance 84a is configured as an induction hob. The set-down plate 12a is configured as a hob plate 58a. In the present case, the hob plate 58a is part of the induction household appliance 84a.

The induction energy transmission system 10a has a supply unit 14a. The supply unit 14a has at least one supply induction element 16a arranged below the set-down plate 12a for the inductive provision of energy. In the present case, the supply unit 14a comprises a total of four supply induction elements 16a, each of which is arranged below the set-down plate 12a. Alternatively, however, the supply unit 14a could have any other number of supply induction elements 16a that is greater than or equal to one.

The inductive energy transmission system 10a has a set-down unit 20a. The set-down unit 20a has a receiving unit 24a with a receiving induction element 26a for receiving the energy inductively provided by the supply unit 14a. In the present case, the set-down unit 20a is configured as a small household appliance, and namely as a food processor 86a. In the present case, the induction energy transmission system 10a has a further set-down unit 22a. The further set-down unit 22a also comprises a receiving unit 24a with a receiving induction element 26a for receiving the energy inductively provided by the supply unit 14a. In the present case, the further set-down unit 22a is configured as a further small household appliance, and namely as a kettle 88a.

The induction energy transmission system 10a has a control unit 18a for controlling the supply unit 14a. The control unit 18a is designed to use a parameter set 28 (see FIG. 7) so as to control the supply unit 14a and to receive at least one parameter 32a (see FIG. 7) of the parameter set 28a from the set-down unit 20a.

The induction energy transmission system 10a has a communication unit 90a. The communication unit 90a is designed for wireless data transmission between the set-down unit 20a and the control unit 18a. In the present case, the communication unit 90a is also provided for wireless data transmission between the further set-down unit 22a and the control unit 18a. The communication unit 90a has a communication element 92a, which is connected to the control unit 18a and is designed for wireless transmission and reception of data. The communication unit 90a has a further communication element 94a, which is arranged in the set-down unit 20a and is designed for wireless transmission and reception of data. The communication unit 90a also has a further communication element 96a, which is arranged in the further set-down unit 22a and is designed for wireless transmission and reception of data. In the present case, the communication unit 90a is configured as an NFC communication unit and is designed for wireless data transmission via NFC between the control unit 18a and the set-down unit 20a and/or the further set-down unit 22a.

The following description of the operating principle of the induction energy transmission system 10a is based on the set-down unit 20a, wherein the statements made can also be transferred analogously to the further set-down unit 22a.

The control unit 18a is designed to receive in addition an information parameter set 36a (see FIG. 7) from the set-down unit 20a and/or the further set-down unit 22a, to use this to determine coefficients 38a (see FIG. 7) of at least one multivariable regression equation and from this to determine at least one correction factor 40a, 42a for at least one parameter 30a, 32a, 34a of the parameter set 28a or determine a new parameter set 44a.

In the present case, the control unit 18a receives both the at least one parameter 32a of the parameter set 28a and the information parameter set 36a by means of the communication unit 90a.

FIG. 2 shows two schematic diagrams illustrating the influencing variables on the self-inductances of the supply induction element 16a and the supply induction element 26a in an operating state of the induction energy transmission system 10a.

A left-hand diagram in FIG. 2 shows a course of a self-inductance 48a of the supply induction element 16a as a function of various influencing variables.

A coupling factor 52a between the supply induction element 16a and the receiving induction element 26a is plotted as a dimensionless characteristic variable on an abscissa 98a of the left-hand diagram of FIG. 2. The self-inductance 48a of the supply induction element 16a is plotted in uH on a left-hand ordinate 100a of the left-hand diagram. A distance 110a (see also FIG. 3) between the supply induction element 16a and the receiving induction element 26a is plotted in mm on a right-hand ordinate 102a of the left-hand diagram. A first measurement series 112a in the left-hand diagram shows the course of the self-inductance 48a of the supply induction element 16a and the coupling factor 52a as a function of the distance 110a without a horizontal offset 46a (see FIG. 3) between the supply induction element 16a and the receiving induction element 26a. A second measurement series 114a in the left-hand diagram shows the course of the self-inductance 48a of the supply induction element 16a and the coupling factor 52a as a function of the distance 110a with a horizontal offset 46a of 20 mm between the supply induction element 16a and the receiving induction element 26a. A third measurement series 116a in the left-hand diagram shows the course of the self-inductance 48a of the supply induction element 16a and the coupling factor 52a as a function of the distance 110a with a horizontal offset 46a of 40 mm between the supply induction element 16a and the receiving induction element 26a.

The coupling factor 52a between the supply induction element 16a and the receiving induction element 26a is plotted as a dimensionless characteristic variable on an abscissa 104a of a right-hand diagram of FIG. 2. A self-inductance 50a of the receiving induction element 26a is plotted in pH on a left-hand ordinate 106a of the right-hand diagram. The distance 110a between the supply induction element 16a and the receiving induction element 26a is plotted in mm on a right-hand ordinate 108a of the right-hand diagram. A first measurement series 118a in the right-hand diagram shows the course of the self-inductance 50a of the receiving induction element 26a and of the coupling factor 52a as a function of the distance 110a without a horizontal offset 46a between the supply induction element 16a and the receiving induction element 26a. A second measurement series 120a in the right-hand diagram shows the course of the self-inductance 50a of the receiving induction element 26a and the coupling factor 52a as a function of the distance 110a with a horizontal offset 46a of 20 mm between the supply induction element 16a and the receiving induction element 26a. A third measurement series 122a in the left-hand diagram shows the course of the self-inductance 48a of the supply induction element 16a and of the coupling factor 52a as a function of the distance 110a at a horizontal offset 46a of 40 mm between the supply induction element 16a and the receiving induction element 26a.

As can be seen from the diagrams in FIG. 2, the distance 110a and the horizontal offset 46a each have a major influence on the self-inductances 48a, 50a of the supply induction element 16a and the receiving induction element 26a, wherein the self-inductances 48a, 50a as parameters 30a, 32a of the parameter set 28a in turn have an influence on the control of the supply unit 14a by the control unit 18a, and the more precisely the values of the self-inductances 48a, 50a used by the control unit 18a for the control correspond to their real values, the more precise the control can be. The control unit 18a is therefore designed to determine a correction factor 40a (see FIG. 7) for the self-inductance 48a of the supply induction element 16a. By means of the correction factor 40a, the control unit 18a calculates a corrected self-inductance of the supply induction element 16a with the aid of the following equation (1):

$${L}_{pm} = {f}_{prx} {L}_{p} \qquad ( 1 )$$

wherein in the equation (1) the expression Lₚₘ represents the corrected self-inductance of the supply induction element 16a, the expression fₚᵣₓ represents the correction factor 40a and the expression Lₚ describes the self-inductance 48a of the supply induction element 16a, which is stored as an output value in a storage unit (not shown) of the control unit 18a as a parameter 30a of the parameter set 28a (see FIG. 7).

The control unit 18a is also designed to determine a correction factor 42a for the self-inductance 50a of the receiving induction element 26a. By means of the correction factor 42a, the control unit 18a calculates a corrected self-inductance of the receiving induction element 26a with the aid of the following equation (2):

$${L}_{sm} = {f}_{stx} {L}_{s} \qquad ( 2 )$$

wherein in the equation (2) the expression Lₛₘ represents the corrected self-inductance of the receiving induction element 26a, the expression fₛₜₓ represents the correction factor 42a, and the expression Lₛ describes the self-inductance 50a of the receiving induction element 26a, which is received by the control unit 18a as a parameter 32a from the set-down unit 20a, and namely wirelessly by means of the communication unit 90a.

The determination of the correction factors 40a, 42a by the control unit 18a is described in more detail below with the aid of FIG. 7.

FIG. 3 shows four schematic representations of possible arrangements between the supply induction element 16a of the supply unit 14a and the receiving induction element 26a of the receiving unit 24a.

The control unit 18a is designed to take into account the horizontal offset 46a between the supply induction element 16a and the receiving induction element 26a when determining the new parameter set 44a.

In an upper left-hand representation of FIG. 3, a first case is shown in which the set-down unit 20a is positioned on the set-down plate 12a in such a way that there is no horizontal offset 46a. A second case is shown in an upper right-hand representation of FIG. 3, in which the set-down unit 20a is positioned on the set-down plate 12a in such a way that a horizontal offset 46a is present, wherein the horizontal offset 46a in the present case is 40 mm.

The control unit 18a is designed to use a vertical distance 62a between the supply induction element 16a and an upper side 64a of the set-down plate 12a when determining the coefficients 38a of the multivariable regression equation. The vertical distance 62a is stored in the storage unit of the control unit 18a. In the two upper representations of FIG. 3, each show the case that the set-down plate 12a is configured as a hob plate 58a, as shown in FIG. 1. In these cases, corresponding to the two upper representations of FIG. 3, the vertical distance 62a between the supply induction element 16a and the upper side 64a of the set-down plate 12a is 4 mm in the present case.

The information parameter set 36a contains a vertical distance 66a between the receiving induction element 26a and the upper side 64a of the set-down plate 12a. The vertical distance 66a is received by the control unit 18a as part of the information parameter set 36a from the set-down unit 20a, and namely wirelessly by means of the communication unit 90a. In the present case, the vertical distance 66a between the receiving induction element 26a and the upper side 64a of the set-down plate 12a has a value of 6 mm.

In two lower representations of FIG. 3, a third case is shown at the bottom left and a fourth case at the bottom right, in which the supply induction element 16a in each case has a greater vertical distance 62a from the upper side 64a of the set-down plate 12a, wherein this vertical distance 62a is stored in the storage unit of the control unit 18a and is 24 mm for the third and fourth cases in each case. The third and fourth case could, by way of example, correspond to a situation in which the set-down plate 12a is not configured as a hob plate 58a but, as in a further embodiment example of an induction energy transmission system 10b shown in FIG. 10, as a kitchen worktop 60b.

In the operating state of the induction energy transmission system 10a, the control unit 18a determines in each case the distance 110a from the sum of the vertical distances 62a, 66a, and namely for all four cases shown in FIG. 3, wherein in the present case the distance 110a is 10 mm in each case in the first and second case and 30 mm in each case in the third and fourth cases.

In the lower left-hand representation of FIG. 3, the set-down unit 20a is again positioned on the set-down plate 12a in such a way that there is no horizontal offset 46a. In the lower right-hand representation of FIG. 3, the set-down unit 20a is again positioned on the set-down plate 12a in such a way that there is a horizontal offset 46a of 40 mm.

FIG. 4 shows a schematic representation of the receiving induction element 26a of the receiving unit 24a and the supply induction element 16a of the supply unit 14a.

The set-down unit 20a has a shielding unit 74a. The information parameter set 36a comprises at least one information parameter 76a relating to the shielding unit 74a. In the present case, the information parameter 76a contains information about a material of the shielding unit 74a. In the present embodiment example, the shielding unit 74a is made of aluminum.

FIG. 5 shows a schematic representation of the receiving unit 24a.

The information parameter set 36a comprises at least one geometric information parameter 68a of the receiving induction element 26a. In the present case, the geometric information parameter 68a is an outer diameter of the receiving induction element 26a. The information parameter set 36a also comprises further geometric information parameters 70a, 72a of the receiving induction element 26a. In the present case, the further geometric information parameter 70a is a thickness of the receiving induction element 26a. The further geometric information parameter 72a in the present case is an internal diameter of the receiving induction element 26a.

The receiving unit 24a has a flux-bundling unit 78a. The flux-bundling unit 78a is shown schematically in FIG. 6. The information parameter set 36a comprises at least one information parameter 80a relating to the flux-bundling unit 78a. In the present case, the information parameter 80a is a number of ferrites 128a of the flux-bundling unit 78a, which is six in the present exemplary embodiment. In the present case, the information parameter set 36a also comprises a further information parameter 82a relating to the flux-bundling unit 78a. In the present case, the further information parameter 82a relating to the flux-bundling unit 78a is a position of the ferrites 128a.

FIG. 7 shows a schematic block diagram illustrating an operating principle of the control unit 18a. The control unit 18a is designed to use the parameter set 28a so as to control the supply unit 14a. The parameter set 28a comprises a plurality of parameters 30a, 32a, 34a, wherein the control unit 18a is designed to receive at least one parameter 32a, in the present case the self-inductance 50a of the receiving induction element 26a, from the set-down unit 20a. In addition, the parameter set 28a contains the parameter 30a, which is stored in the storage unit, wherein the parameter 30a in the present case is the self-inductance 48a of the supply induction element 16a, Furthermore, the parameter set 28a comprises at least one parameter 34a, which is measured by the control unit 18a in an operating state of the supply unit 14a. In the present case, the parameter 34a is, by way of example, an average current strength with which the supply induction element 16a is operated in the operating state. In the present case, the parameter set 28a comprises at least one further parameter 132a, which is measured in the operating state of the supply unit 14a, wherein the further parameter 132a in the present case is an average electrical power for operating the supply induction element 16a. The control unit 18a is designed to determine an equivalent resistance 134a between the supply unit 14a and the receiving unit 24a from the parameter 34a and the further parameter 132a, and namely with the aid of the following equation (3):

$${R}_{eq} = \frac{{P}_{avg}}{{I}_{rms}^{2}} \qquad ( 3 )$$

wherein in the equation (3) the expression R_{eq} represents the equivalent resistance 134a, the expression P_{avg} represents the average electrical power determined as a further parameter 132a and the expression Iᵣₘₛ represents the average current strength determined as a parameter 34a.

A multivariable regression equation (4) is shown below, which the control unit 18a uses to determine the correction factor 40a:

$${f}_{prx} = {e}^{{c}_{7} {k}^{2} - {c}_{8} k - {c}_{9} {a}^{2} {k}^{2}} \qquad ( 4 )$$

wherein in the multivariable regression equation (4) the expression fₚᵣₓ represents the correction factor 40a, the expression e represents the Euler number and the expression k represents the coupling factor 52a. The expressions c₇, c₈ and c₉ represent respectively a coefficient 38a7, 38a8, 38a9 of the multivariable regression equation (4), which the control unit 18a determines from the information parameter set 36a or which are contained as specific values in the information parameter set 36a.

A further multivariable regression equation (5) is shown below, which the control unit 18a uses to determine the correction factor 42a:

$${f}_{stx} = {e}^{{c}_{4} {k}^{2} - {c}_{5} k - {c}_{6} {a}^{2} {k}^{2}} \qquad ( 5 )$$

wherein in the multivariable regression equation (5) the expression fₛₜₓ represents in turn the correction factor 42a, the expression k represents in turn the coupling factor 52a and the expression e represents in turn the Euler number. The expressions c₄, c₅ and c₆ represent respectively a coefficient 38a4, 38a5, 38a6 of the multivariable regression equation (5), which the control unit 18a determines from the information parameter set 36a or which are contained as specific values in the information parameter set 36a.

An equation (6) is given below, by means of which the control unit determines an orientation 130a between the supply induction element 16a and the receiving induction element 26a when determining the new parameter set 44a, taking into account the horizontal offset 46a between the supply induction element 16a and the receiving induction element 26a:

$$a = \sqrt{\frac{ln ( \frac{{k}_{1}}{{c}_{1}} ) - {c}_{2} \cdot d}{{c}_{3}}} \qquad ( 6 )$$

wherein in the equation (6) the expression a represents the orientation 130a, the expression In represents the natural logarithm, the expression k represents in turn the coupling factor 52a and the expression d represents the distance 110a between the receiving induction element 26a and the supply induction element 16a. The expressions c₁, c₂ and c₃ represent respectively a coefficient 38a1, 38a2, 38a3 of the equation (6), which the control unit 18a determines from the information parameter set 36a or which are contained as specific values in the information parameter set 36a.

The control unit 18a determines the coefficient 38al with the aid of the following equation (7):

$${c}_{1} = \frac{{k}_{1}}{{e}^{{c}_{2} {d}_{1}}} \qquad ( 7 )$$

wherein in the equation (7) the expression c₁ represents in turn the coefficient 38a1, the expression c₂ represents the coefficient 38a2 and the expression e represents the Euler number. The expression k₁ represents the coupling factor 52a and the expression d₁ represents the distance 110a between the receiving induction element 26a and the supply induction element 16a, wherein the index 1 in each case represents the first case shown in the top left of FIG. 3. For each of the cases shown in FIG. 3, a value for the coupling factor 52a, the self-inductance 48a of the supply induction element 16a and the self-inductance 50a is stored in the set-down unit 20a, wherein these values were determined in standardized tests which were carried out under conditions corresponding to the cases shown in FIG. 3 and the control unit 18a receives these values in the operating state of the induction energy transmission system 10a as components of the information parameter set 36a from the set-down unit 20a and uses them to determine the coefficients 38a.

The control unit 18a determines the coefficient 38a2 with the aid of the following equation (8):

$${c}_{2} = \frac{ln ( \frac{{k}_{1}}{{k}_{3}} )}{( {d}_{1} - {d}_{3} )} \qquad ( 8 )$$

wherein in the equation (8) the expression c₂ represents in turn the coefficient 38a2 and the expression In represents the natural logarithm. The expression k represents in turn the coupling factor 52a and the expression d represents the distance 110a between the receiving induction element 26a and the supply induction element 16a, wherein the index 1 represents in turn in each case the first case shown in the top left of FIG. 3 and the index 3 represents the third case shown in the bottom left of FIG. 3.

The control unit 18a determines the coefficient 38a3 with the aid of the following equation (9):

$${c}_{3} = \frac{( ln ( \frac{{k}_{2 , 4}}{{c}_{1}} ) - {c}_{2} {d}_{2 , 4}}{{a}_{2 , 4}^{2}} \qquad ( 9 )$$

wherein in the equation (9) the expression c₂ represents in turn the coefficient 38a2 and the expression c₃ represents in turn the coefficient 38a3 and the expression In denotes in turn the natural logarithm. In the equation 9, the expression a again represents the orientation 130a, the expression k represents in turn the coupling factor 52a and the expression d represents in turn the distance 110a between the receiving induction element 26a and the supply induction element 16a, wherein the index 2 in each case represents the second case shown in the top right of FIG. 3 and the index 4 represents the fourth case shown in the bottom right of FIG. 3. With the aid of the value stored in the storage unit for the horizontal distance 62a, the control unit 18a determines whether the second or the fourth case is present and selects the corresponding values for the orientation 130a, the coupling factor 52a and the distance 110a from the information parameter set so as to determine the coefficient 38a3.

The control unit 18a determines the coefficient 38a4 with the aid of the following equation (10):

$${c}_{4} = \frac{( ln ( {f}_{stx 1 , 3} ) + {c}_{5} {k}_{1 , 3} )}{{k}_{1 , 3}^{2}} \qquad ( 10 )$$

wherein in the equation (10) the expression c₄ represents in turn the coefficient 38a4 and the expression c₅ represents in turn the coefficient 38a5 and the expression In denotes in turn the natural logarithm. In the equation (10), the expression fₛₜₓ represents in turn the correction factor 42a and the expression k represents in turn the coupling factor 52a, wherein the index 1 represents in turn the first case shown in the top left of FIG. 3 and the index 3 represents the third case shown in the bottom left of FIG. 3. Values for the correction factor 42a for the four cases shown in FIG. 3 are each contained in the information parameter set 36a.

The coefficients 38a5 and 38a8 are constant in the present case and each have the value shown in the equation (11):

$${c}_{5 , 8} = - 0.1 \qquad ( 11 )$$

In the equation (11), the expressions c_{5,8} represent in turn the coefficients 38a5 and 38a8, wherein the said value of these coefficients is contained in the information parameter set 36a.

The control unit 18a determines the coefficient 38a6 with the aid of the following equation (12):

$${c}_{6} = \frac{( ln ( {f}_{stx 2 , 4} ) + {c}_{4} {k}_{2 , 4}^{2} + {c}_{5} {k}_{2 , 4} )}{( {k}_{2 , 4}^{2} {a}_{2 , 4}^{2} )} \qquad ( 12 )$$

wherein in the equation (12) the expression c₄ represents in turn the coefficient 38a4, the expression c₅ represents in turn the coefficient 38a5 and the expression c₆ represents in turn the coefficient 38a6. The expression In also denotes the natural logarithm in the equation (12). In the equation (12), the expression fₛₜₓ represents in turn the correction factor 42a, the expression k represents in turn the coupling factor 52a and the expression a represents the orientation 130a, wherein the index 2 represents in turn in each case the second case shown in the top right of FIG. 3 and the index 4 represents the fourth case shown in the bottom right of FIG. 3.

The control unit 18a determines the coefficient 38a7 with the aid of the following equation (13):

$${c}_{7} = \frac{( ln ( {f}_{prx 1 , 3} ) + {c}_{8} {k}_{1 , 3} )}{{k}_{1 , 3}^{2}} \qquad ( 13 )$$

wherein in the equation (13) the expression c₇ represents in turn the coefficient 38a7 and the expression c₈ represents in turn the coefficient 38a8 and the expression In denotes in turn the natural logarithm. Also in the equation (13), the expression fₚᵣₓ represents in turn the correction factor 40a and the expression k represents in turn the coupling factor 52a, wherein the index 1 represents in turn in each case the first case shown in the top left of FIG. 3 and the index 3 represents the third case shown in the bottom left of FIG. 3. Values for the correction factor 40a for the four cases shown in FIG. 3 are in turn each contained in the information parameter set 36a.

The control unit 18a determines the coefficient 38a9 with the aid of the following equation (14):

$${c}_{9} = \frac{( ln ( {f}_{prx 2 , 4} ) - {c}_{7} {k}_{2 , 4}^{2} + {c}_{8} {k}_{2 , 4} )}{( {k}_{2 , 4}^{2} {a}_{2 , 4}^{2} )} \qquad ( 14 )$$

wherein in the equation (14) the expression c₇ represents in turn the coefficient 38a7, the expression c₈ represents in turn the coefficient 38a8 and the expression c₉ represents the coefficient 38a9. The expression In also denotes the natural logarithm in the equation (14). In the equation (14), the expression fₚᵣₓ represents in turn the correction factor 40a, the expression k represents in turn the coupling factor 52a and the expression a represents the orientation 130a, wherein the index 2 represents in turn the second case shown in the top right of FIG. 3 and the index 4 represents the fourth case shown in the bottom right of FIG. 3.

The following general relationship described in the equation (15) exists between the coupling factor 52a, the self-inductance 48a of the power supply induction element 16a, the self-inductance 50a of the receiving induction element 26a, and a mutual inductance between the supply induction element 16a and the receiving induction element 26a in the operating state of the induction power transmission system 10a:

$${L}_{g} = k \sqrt{{L}_{sm} {L}_{pm}} . \qquad ( 15 )$$

wherein in the equation (15) the expression L_{g} represents the mutual inductance, the expression k represents in turn the coupling factor 52a, the expression Lₛₘ represents the corrected self-inductance of the receiving induction element 26a and the expression Lₚₘ represents the corrected self-inductance of the supply induction element 16a.

The control unit 18a is designed to determine a correction factor 54a for a load resistance 56a of the set-down unit 20a. In order to determine the correction factor 54a for the load resistance 56a, the control unit 18a is designed to first determine the load resistance 56a with the aid of the following equation (16):

$${R}_{eq} = \frac{{ω}^{2} {L}_{g}^{2} {R}_{load}}{{R}_{load}^{2} + {( ω {L}_{sm} - \frac{1}{ω {C}_{2}} )}^{2}} , \qquad ( 16 )$$

In the equation (16), the expression R_{eq} represents in turn the equivalent resistance 134a, L_{g} represents the mutual inductance, R_{load} represents the load resistance 56a, Lₛₘ represents the corrected self-inductance of the receiving induction element 26a, ω represents the angular frequency and C₂ represents a capacitance of a compensation capacitor (not shown) which is connected to the receiving induction element 26a, wherein the capacitance of the compensation capacitor is contained in the information parameter set 36a. The following applies to the angular frequency ω:

$$ω = 2 π f \qquad ( 17 )$$

wherein in the equation (17) π represents the circular constant and f represents a frequency of an alternating current with which the control unit 18a operates the supply induction element 16a.

The control unit 18a is designed to determine a value for the load resistance 56a by equating the equation (16) with the value for the equivalent resistance 134a determined with the aid of equation (3) and by resolving it according to R_{load}.

In the present case, the parameter set 28a comprises at least one further parameter 168a, which is measured in the operating state of the supply unit 14a, wherein the further parameter 168a in the present case is an equivalent inductance of the set-down unit 20a. The control unit 18a is designed to determine the coupling factor 52a with the aid of the following equation (18) so as to determine the correction factor 54a for the load resistance 56a:

$${k}_{{L}_{eq}} = \sqrt{\frac{( {L}_{pm} - {L}_{eq} ) ( {R}_{load}^{2} + ( ω {L}_{sm} - {( \frac{1}{ω {C}_{2}} )}^{2} )}{\text{?}}} . \qquad ( 18 )$$

$$\text{?} \text{indicates text missing or illegible when filed}$$

wherein in the equation (18) k_{Leq} represents the coupling factor 52a as a function of the equivalent inductance of the set-down unit 20a, Lₚₘ represents the corrected self-inductance of the supply induction element 16a, L_{eq} represents the equivalent inductance of the set-down unit 20a, R_{load} represents the load resistance 56a, Lₛₘ represents the corrected self-inductance of the receiving induction element 26a, w represents the angular frequency and C₂ represents the capacitance of the compensation capacitor connected to the receiving induction element 26a.

The control unit 18a is designed to use the following equation (19) so as to determine the correction factor 54a for the load resistance 56a:

$${k}_{{R}_{eq}} = \sqrt{\frac{{R}_{eq} ( {R}_{load}^{2} + ( ω {L}_{sm} - {( \frac{1}{ω {C}_{2}} )}^{2} )}{{ω}^{2} {L}_{pm} {L}_{sm} {R}_{load}} .} \qquad ( 19 )$$

wherein in the equation (19) k_{Req} represents the coupling factor 52a as a function of the equivalent resistance 134a of the set-down unit 20a, Lₚₘ represents the corrected self-inductance of the supply induction element 16a, L_{eq} represents the equivalent inductance of the set-down unit 20a, R_{load} represents the load resistance 56a, Lₛₘ represents the corrected self-inductance of the receiving induction element 26a, ω represents the angular frequency and C₂ represents the capacitance of the compensation capacitor connected to the receiving induction element 26a.

The control unit 18a is designed to equate the equation (19) with the value of the coupling factor 52a determined with the aid of the equation (18) and to resolve it according to R_{load}. In order to determine the correction factor 54a for the load resistance 56a, the control unit 18a is designed to compare the value of the load resistance 56a determined by means of equations (3) and (16) with the value of the load resistance 56a determined by means of equations (18) and (19) and to calculate the correction factor 54a from this. The control unit 18a is further designed to determine a frequency 136a and/or a duty cycle 138a and/or a burst mode 140a with the aid of the corrected load resistance 56a determined in this way, in order to operate the supply induction element 16a with it.

FIG. 8 shows two schematic diagrams illustrating the correction factors 40a, 42a. The coupling factor 52a is plotted as a dimensionless characteristic variable on an abscissa 142a of a left-hand diagram. The correction factor 40a is plotted as a dimensionless characteristic variable on an ordinate 144a. A first measurement series 146a in the left-hand diagram shows the course of the correction factor 40a as a function of the coupling factor 52a in the event that there is no horizontal offset 46a (see FIG. 3) between the supply induction element 16a and the receiving induction element 26a. Circular measurement points of the first measurement series 146a each represent correction factors 40a determined by the control unit 18a. Rectangular measurement points of the first measurement series 146a each represent real measurement values, wherein the correction factor was calculated with the aid of the following equation (20), which is obtained by adapting equation (1):

$${f}_{prx} = \frac{{L}_{pr}}{{L}_{p}} \qquad ( 20 )$$

wherein in the equation (20) the expression fₚᵣₓ represents in turn the correction factor 40a and the expression Lₚ represents the self-inductance 48a of the supply induction element 16a stored in the storage unit of the control unit 18a. The expression Lₚᵣ in the equation (20) represents a self-inductance of the supply induction element 16a measured in an operating state of the induction energy transmission system 10a.

A second measurement series 148a in the left-hand diagram shows the course of the correction factor 40a as a function of the coupling factor 52a in the event that there is a horizontal offset 46a (see FIG. 3) of 20 mm between the supply induction element 16a and the receiving induction element 26a. Circular measurement points of the second measurement series 146a represent in turn correction factors 40a determined by the control unit 18a. Rectangular measurement points of the second measurement series 148a represent in turn real measurement values from which the correction factor 40a was calculated with the aid of the above equation (20).

A third measurement series 150a in the left-hand diagram shows the course of the correction factor 40a as a function of the coupling factor 52a in the event that there is a horizontal offset 46a (see FIG. 3) of 40 mm between the supply induction element 16a and the receiving induction element 26a. Circular measurement points of the third measurement series 150a represent in turn correction factors 40a determined by the control unit 18a. Rectangular measurement points of the third measurement series 150a each represent in turn real measurement values from which the correction factor 40a was calculated with the aid of the above equation (20).

The coupling factor 52a is plotted as a dimensionless characteristic variable on an abscissa 152a of a right-hand diagram in FIG. 8. The correction factor 42a is plotted as a dimensionless characteristic variable on an ordinate 154a of the right-hand diagram. A first measurement series 156a in the right-hand diagram shows the course of the correction factor 42a as a function of the coupling factor 52a in the event that there is no horizontal offset 46a (see FIG. 3) between the supply induction element 16a and the receiving induction element 26a. Circular measurement points of the first measurement series 156a each represent correction factors 42a determined by the control unit 18a. Rectangular measurement points of the first measurement series 156a each represent real measurement values, wherein the correction factor was calculated with the aid of the following equation (21), which is obtained by adapting equation (2):

$${f}_{stx} = \frac{{L}_{sr}}{{L}_{s}} \qquad ( 21 )$$

wherein in the equation (21), the expression fₛₜₓ represents in turn the correction factor 42a and the expression Lₛ describes the self-inductance 50a of the supply induction element 26a which is received as a parameter 32a from the set-down unit 20a, and namely wirelessly by means of the communication unit 90a. The expression Lₛᵣ in the equation (21) represents a self-inductance of the supply induction element 16a measured in an operating state of the induction energy transmission system 10a.

A second measurement series 158a of the right-hand diagram shows the course of the correction factor 42a as a function of the coupling factor 52a in the event that there is a horizontal offset 46a (see FIG. 3) of 20 mm between the supply induction element 16a and the receiving induction element 26a. Circular measurement points of the second measurement series 158a each represent in turn correction factors 42a determined by the control unit 18a. Rectangular measurement points of the second measurement series 158a each represent in turn real measurement values from which the correction factor 42a was calculated with the aid of the above equation (21).

A third measurement series 160a in the left-hand diagram shows the course of the correction factor 42a as a function of the coupling factor 52a in the event that there is a horizontal offset 46a (see FIG. 3) of 40 mm between the supply induction element 16a and the receiving induction element 26a. Circular measurement points of the third measurement series 160a each represent in turn correction factors 42a determined by the control unit 18a. Rectangular measurement points of the third measurement series 160a each represent in turn real measurement values from which the correction factor 42a was calculated with the aid of the above equation (21).

FIG. 9 shows a schematic method flow chart of a method for operating the induction energy transmission system 10a. The method comprises at least two method steps 162a, 164a. In a first method step 162a of the method, the parameter set 28a is used so as to control the supply unit 14a, wherein at least one parameter 32a of the parameter set 28a is provided by the set-down unit 20a. In a second method step 164a of the method, the information parameter set 36a is additionally provided by the set-down unit 20a, which is used to determine the coefficients 38a of the at least one multivariable regression equation, wherein from this the at least one correction factor 40a, 42a for at least one of the parameters 30a, 32a, 34a of the parameter set 28a is determined or the new parameter set 44a is determined.

FIG. 10 shows a further exemplary embodiment of the invention. The following descriptions are essentially limited to the differences between the exemplary embodiments, wherein reference can be made to the description of the exemplary embodiment in FIGS. 1 to 9 with regard to components, features and functions that remain the same. In order to differentiate between the exemplary embodiments, the letter a in the reference characters of the exemplary embodiment in FIGS. 1 to 9 is replaced by the letter b in the reference characters of the exemplary embodiment in FIG. 10. With regard to components with the same designation, in particular with regard to components with the same reference characters, reference can also be made in principle to the drawings and/or the description of the exemplary embodiment of FIGS. 1 to 9.

FIG. 10 shows a schematic representation of a further exemplary embodiment of an induction energy transmission system 10b. The induction energy transmission system 10b has a set-down plate 12b and a supply unit 14b. The supply unit 14b has at least one supply induction element 16b arranged below the set-down plate for the inductive provision of energy. In the present case, the supply unit 14b comprises a total of two supply induction elements 16b. The induction energy transmission system 10b has a control unit 18b for controlling the supply unit 14b.

In contrast to the preceding exemplary embodiment, the induction energy transmission system 10b is configured as a small household appliance supply system and comprises an induction household appliance 84b, which is configured as a small household appliance supply device and which comprises the control unit 18b and the supply unit 14b. The set-down plate 12b of the induction energy transmission system 10b is configured as a kitchen worktop 60b.

The induction energy transmission system 10b comprises a set-down unit 20b for setting down on the set-down plate 12b. The set-down unit 20b has a receiving unit 24b with a receiving induction element 26b for receiving the energy inductively provided by the supply unit 14b. In the present case, the set-down unit 20b is configured as a small household appliance, and namely as a food processor 86b. In the present case, the induction energy transmission system 10b has a further set-down unit 22b. The further set-down unit 22b also comprises a receiving unit with a receiving induction element (not shown) for receiving the energy inductively provided by the supply induction element 16b of the supply unit 14b. The further set-down unit 22b is configured as a cooking pot 166b with an integrated stirring function.

The induction energy transmission system 10b has a communication unit 90b for wireless communication between the control unit 18b and the set-down unit 20b and/or the further set-down unit 22b. The communication unit 90b has a communication element 92b, which is connected to the control unit 18b, and two further communication elements 94b, 96b, which are arranged in the set-down unit 20b and in the further set-down unit 22b respectively. In the present case, the communication unit 90b is configured as an NFC communication unit and is designed for wireless communication via NFC between the control unit 18b and the set-down unit 20b and/or the further set-down unit 22b.

Analogous to the preceding exemplary embodiment, the control unit 18b is designed to use a parameter set (not shown) so as to control the supply unit 14a and to receive at least one parameter (not shown) of the parameter set from the set-down unit 20b. In addition, the control unit 18b is designed to receive in addition an information parameter set (not shown) from the set-down unit 20b and/or the further set-down unit 22b, to use this to determine coefficients (not shown) of at least one multivariable regression equation and from this to determine at least one correction factor (not shown) for at least one parameter of the parameter set or determine a new parameter set (not shown). With regard to an operating principle of the control unit 18b, reference can be made to the above description of the first embodiment example.

### REFERENCE CHARACTERS

10 Induction energy transmission system
12 Set-down plate
14 Supply unit
16 Supply induction element
18 Control unit
20 Set-down unit
22 Further set-down unit
24 Receiving unit
26 Receiving induction element
28 Parameter set
30 Parameter
32 Parameter
34 Parameter
36 Information parameter set
38 Coefficient
40 Correction factor
42 Correction factor
44 New parameter set
46 Horizontal offset
48 Self-inductance
50 Self-inductance
52 Coupling factor
54 Correction factor
56 Load resistance
58 Hob plate
60 Kitchen worktop
62 Vertical distance
64 Upper side
66 Vertical distance
68 Geometric information parameter
70 Further geometric information parameter
72 Further geometric information parameter
74 Shielding unit
76 Information parameter
78 Flux-bundling unit
80 Information parameter
82 Further information parameter
84 Induction household appliance
86 Food processor
88 Kettle
90 Communication unit
92 Communication element
94 Further communication element
96 Further communication element
98 Abscissa
100 Left ordinate
102 Right ordinate
104 Abscissa
106 Left ordinate
108 Right ordinate
110 Distance
112 First measurement series
114 Second measurement series
116 Third measurement series
118 First measurement series
120 Second measurement series
122 Third measurement series
128 Ferrite
130 Orientation
132 Further parameter
134 Equivalent resistance
136 Frequency
138 Duty cycle
140 Burst mode
142 Abscissa
144 Ordinate
146 First measurement series
148 Second measurement series
150 Third measurement series
152 Abscissa
154 Ordinate
156 First measurement series
158 Second measurement series
160 Third measurement series
162 First method step
164 Second method step
166 Cooking pot
168 Further parameter

1-15. (canceled)

16. An induction energy transmission system, in particular an induction cooking system, the induction energy transmission system comprising:
a set-down plate;
a supply unit comprising a supply induction element arranged below the set-down plate and designed to inductively provide energy;
a set-down unit comprising a receiving unit with a receiving induction element designed to receive the inductively provided energy; and
a control unit designed to control the supply unit by using a parameter set so as to control the supply unit and to receive a parameter of the parameter set from the set-down unit, said control unit being designed to receive in addition an information parameter set from the set-down unit, to determine a coefficient of a multivariable regression equation and based on the coefficient to determine a correction factor for a parameter of the parameter set or determine a new parameter set.

17. The induction energy transmission system of claim 16, wherein the control unit is designed to take into account a horizontal offset between the supply induction element and the receiving induction element when determining the new parameter set.

18. The induction energy transmission system of claim 16, wherein the control unit is designed to determine a correction factor for a self-inductance of the supply induction element.

19. The induction energy transmission system of claim 16, wherein the control unit is designed to determine a correction factor for a self-inductance of the receiving induction element.

20. The induction energy transmission system of claim 16, wherein the control unit is designed to determine a correction factor for a load resistance of the set-down unit.

21. The induction energy transmission system of claim 16, wherein the set-down plate is configured as a hob plate.

22. The induction energy transmission system of claim 16, wherein the set-down plate is configured as a kitchen worktop.

23. The induction energy transmission system of claim 16, wherein the control unit is designed to use a vertical distance between the supply induction element and an upper side of the set-down plate when determining the coefficient of the multivariable regression equation.

24. The induction energy transmission system of claim 16, wherein the information parameter set contains a vertical distance between the receiving induction element and an upper side of the set-down plate.

25. The induction energy transmission system of claim 16, wherein the information parameter set comprises a geometric information parameter of the receiving induction element.

26. The induction energy transmission system of claim 16, wherein the set-down unit comprises a shielding unit and the information parameter set comprises an information parameter relating to the shielding unit.

27. The induction energy transmission system of claim 16, wherein the receiving unit comprises a flux-bundling unit and the information parameter set comprises an information parameter relating to the flux-bundling unit.

28. A set-down unit, in particular a small household appliance, of an induction energy transmission system, the set-down unit designed for placement on a set-down plate of the induction energy transmission system and comprising a receiving unit with a receiving induction element designed to receive an inductively provided energy, the set-down unit designed to provide an information parameter set to a control unit of the induction energy transmission system for determining a coefficient of a multivariable regression equation and based on the coefficient for determining a correction factor for a parameter of the parameter set or determining a new parameter set.

29. The set-down unit of claim 28, further comprising a shielding unit to protect against interference from the alternating electromagnetic field.

30. An induction household appliance, in particular an induction hob, of an induction energy transmission system, the induction household appliance comprising:
a supply unit comprising a supply induction element designed to inductively provide energy; and
a control unit designed to control the supply unit by using a parameter set so as to control the supply unit and to receive a parameter of the parameter set from a set-down unit of the induction energy transmission system, said control unit being designed to receive in addition an information parameter set from the set-down unit, to determine a coefficient of a multivariable regression equation and based on the coefficient to determine a correction factor for a parameter of the parameter set or determine a new parameter set.

31. A method for operating the induction energy transmission system of claim 16, the method comprising:
inductively providing energy by the supply induction element of the supply unit;
transmitting the inductively provided energy to the receiving induction element of the set-down unit;
controlling the supply unit by using a parameter of a parameter set from the set-down unit;
the set-down unit additionally providing an information parameter set to determine a coefficient of a multivariable regression equation; and
determining a correction factor for a parameter of the parameter set or a new parameter set based on the determined coefficient.

32. The method of claim 31, further comprising taking into account a horizontal offset between the supply induction element and the receiving induction element when determining the new parameter set.

33. The method of claim 31, further comprising determining a correction factor for a self-inductance of the supply induction element.

34. The method of claim 31, further comprising determining a correction factor for a self-inductance of the receiving induction element.

35. The method of claim 31, further comprising determining a correction factor for a load resistance of the set-down unit.

36. The method of claim 31, further comprising using a vertical distance between the supply induction element and an upper side of the set-down plate when determining the coefficient of the multivariable regression equation.
